(19) United States
(12) Patent Application Publication
(10) Pub. No.: US 2012/0210030 A1
(43) Pub. Date: Aug. 16, 2012

(54) AUTOMATION SYSTEM AND METHOD FOR OPERATING AN AUTOMATION SYSTEM

(75) Inventors: Harald Karl, Fuerth (DE); Karl-Heinz Kern, Nuernberg (DE)

(73) Assignee: SIEMENS AKTIENGESELLSCHAFT, MUENCHEN (DE)

(21) Appl. No.: 13/503,500

(22) PCT Filed: Oct. 20, 2010
(86) PCT No.: PCT/EP2010/065796

§ 371 Date: Apr. 23, 2012

(30) Foreign Application Priority Data
Oct. 23, 2009 (DE) 10 2009 050 449.4

(51) Int. Cl. G06F 13/42

(52) U.S. Cl. 710/110

(57) ABSTRACT

An automation system has a first automation controller and a redundant second automation controller. The automation system further includes at least one peripheral unit and a bus system interconnecting the two automation controllers and the at least one peripheral unit. The peripheral unit is connected to the bus system through a bus interface unit. The bus interface unit has a first bus controller associated with the first automation controller, a second bus controller associated with the second automation controller, and a switching unit for switching between the two bus controllers. A method for operating the automation system selects one of the two automation controllers for controlling the automation system, depending on the situation.

The invention relates to an automation system having an automation controller, at least one peripheral unit and a bus system and to a method for operating such an automation system.

Known automation systems of this type are often based on so-called master/slave communication between an automation controller and peripheral units to be controlled with the latter. In this case, the automation controller assumes the role of the master and the peripheral units assume the roles of the slaves. The master communicates with the slaves via the bus system, while the slaves do not communicate with one another or communicate with one another only to a limited extent. Automation systems on which high availability demands are imposed, for example for the automation of rail vehicles, must make it possible to intercept or compensate for failures or availability deficits of an automation controller.

The invention is based on the object of specifying an automation system with improved operational reliability. The invention is also based on the object of specifying a method for reliably operating such an automation system.

According to the invention, the object is achieved, with respect to the automation system, by the features of claim 1 and, with respect to the method, by the features of claim 4.

The subclaims relate to advantageous refinements of the invention.

The automation system according to the invention has a first automation controller and a redundant second automation controller. It also has at least one peripheral unit and a bus system which connects the two automation controllers and the at least one peripheral unit to one another. The at least one peripheral unit is connected to the bus system by means of an associated bus interface assembly. The bus interface assembly comprises a first bus controller which is assigned to the first automation controller and is connected to the latter via the bus system, a second bus controller which is assigned to the second automation controller and is connected to the latter via the bus system, and a changeover unit for changing over between the two bus controllers.

As a result of the fact that the automation system has two identical automation controllers, failure or unavailability of one of the automation controllers can be compensated for by the second automation controller. This advantageously increases the operational reliability of the automation system.

As a result of the fact that the bus interface assemblies of the peripheral units each have two bus controllers which are each assigned to a different one of the two automation controllers and are connected to the latter, it is possible, in the event of a change of the automation controller controlling the automation system, for the automation controller which assumes control to very quickly completely access the peripheral units via the bus controllers assigned to it since the connection to these bus controllers already exists and does not need to be set up first. This reduces a changeover time in the event of a change in the control of the automation system, which is particularly advantageous when high reliability requirements with short changeover times are imposed on the automation system.

In this case, the changeover time is advantageously reduced with little hardware outlay and without additional software outlay since only the number of bus controllers is increased, while all other components of the bus interface assemblies and peripheral units remain unchanged.

In one preferred refinement, the bus system is a field bus system.

As a result, known advantageous properties of a field bus system are implemented by the automation system. In particular, wiring complexity and costs are reduced, a high degree of reliability and availability is achieved by means of short signal paths and it is possible to easily expand and change the automation system.

The first bus controller of a bus interface assembly is preferably directly connected to the bus system, and the second bus controller is connected to the first bus controller and is indirectly connected to the bus system via this connection.

As a result, only one of the two bus controllers of a bus interface assembly needs to be connected to the field bus system, with the result that the connection of the bus interface assembly to the bus system need not be changed in comparison with a bus interface assembly with only one bus controller. As a result, the hardware outlay for the second bus controller is advantageously reduced and the implementation of the automation system according to the invention is simplified.

In the method according to the invention for operating an automation system according to the invention, one of the two automation controllers is selected to control the automation system on the basis of the situation. Furthermore, that bus controller which is assigned to the automation controller respectively selected to control the automation system is selected to access the peripheral unit in the bus interface assembly of the at least one peripheral unit.

Selecting one of the automation controllers to control the automation system on the basis of the situation makes it possible to adapt control to situational requirements. In particular, if one automation controller fails or is not available, the automation system can be controlled by the respective other automation controller, thus advantageously increasing the operational reliability of the automation system, as already described above.

Selecting that bus controller which is assigned to the respective controlling automation controller for access to the peripheral unit by this automation controller enables the advantageous reduction (already mentioned above) in the changeover times in the event of a change of the controlling automation controller.

In one refinement of the method, the automation system is controlled using the first automation controller, if the latter is available for control and is ready for operation, and is controlled using the second automation controller if the first automation controller is not ready for operation or is not available.

As a result, an available automation controller which is ready for operation is easily and efficiently selected to control the automation system in an operationally reliable manner.

The availability and readiness for operation of each of the automation controllers are preferably continuously monitored.

As a result, failure or unavailability of an automation controller can be reliably detected without delay and the control of the automation system can be passed to the respective other automation controller if necessary.

In this case, one refinement of the method provides for the two automation controllers to monitor one another for availability and readiness for operation.

As a result, the availability and readiness for operation of the automation controllers are monitored by the automation controllers themselves, with the result that there is no need for any additional monitoring means.

Furthermore, the bus controllers of the bus interface assembly of the at least one peripheral unit are preferably informed of each change of the automation controller selected to control the automation system via the bus system.

As a result, a change of the controlling automation controller is immediately indicated to the bus controllers, with the result that access to the peripheral units can be changed over to those bus controllers which are assigned to the automation controller assuming control.

Alternatively or additionally, the bus controllers of the bus interface assembly of the at least one peripheral unit are preferably cyclically informed, at predefinable intervals of time, of which of the two automation controllers is currently selected to control the automation system via the bus system.

This also makes it possible for the bus controllers to detect a change of the controlling automation controller and to react thereto. If the cyclical notification of the bus controllers is used in addition to notification each time the controlling automation controller is changed, transmission errors, for example a loss of a message relating to a change of the controlling automation controller, can also be advantageously compensated for.

Another preferred alternative or additional refinement of the method provides for a current system state of the at least one peripheral unit to be transmitted in the event of a change of the bus controller accessing the at least one peripheral unit from the bus controller handing over access to the bus controller assuming access.

In the event of a change of the controlling automation controller and associated changing over to the bus controllers assigned to this automation controller, important information which is needed to access the peripheral unit in an error-free manner can be transmitted to a bus controller assuming access to a peripheral unit from the bus controller transferring access to said bus controller. As a result, a bus controller assuming access does not need to first determine this information itself, thus advantageously reducing the changeover time further. Such information is, for example, information relating to the insertion and removal of modules on the peripheral unit or settings and writing operations which were performed by the peripheral unit on the bus controller transferring access, for example the configuration of ports or the writing of diagnostic information.

Further features and details of the invention are described below using exemplary embodiments and with reference to drawings, in which:

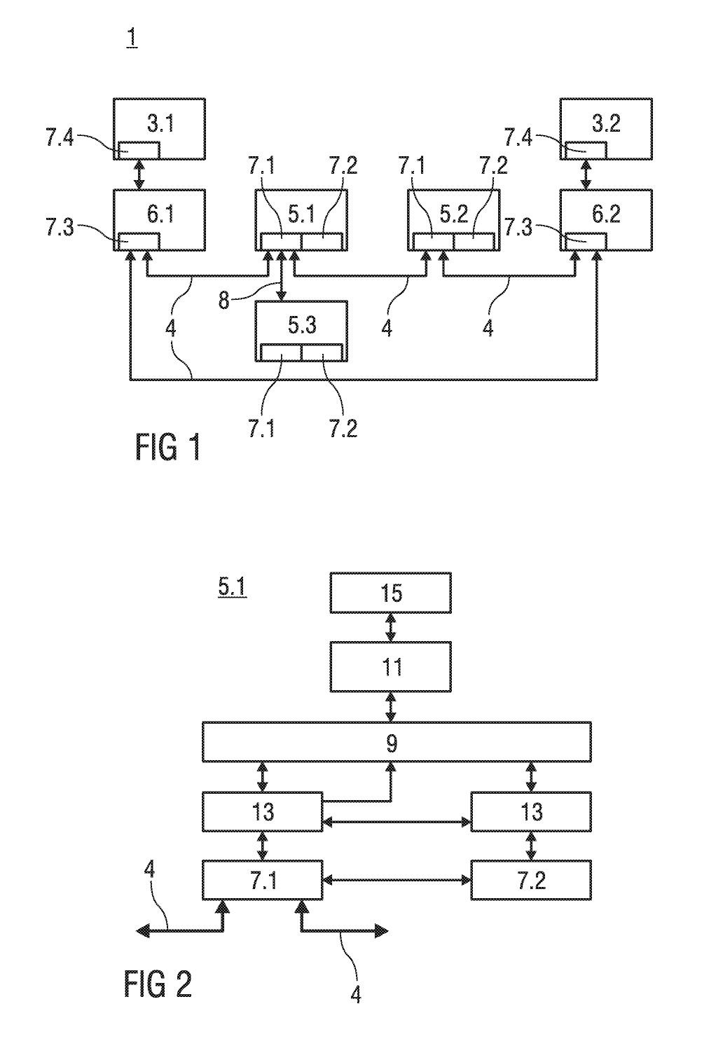

FIG. 1 shows a block diagram of an automation system having two automation controllers and three bus interface assemblies of peripheral units connected to said controllers via a bus system, and

FIG. 2 shows a block diagram of a bus interface assembly having two bus controllers and a changeover unit.

Mutually corresponding parts are provided with the same reference symbols in all figures.

FIG. 1 schematically shows a block diagram of an automation system 1 having two automation controllers 3.1, 3.2 and three bus interface assemblies 5.1, 5.2, 5.3 of peripheral units (not illustrated in any more detail) connected to said controllers via a bus system 4.

The automation system 1 may be, for example, a system for controlling doors of rail vehicles. In this example, a possible peripheral unit may be, for example, a door controller for automatically controlling the automatic closing and opening of a door of the rail vehicle. However, the invention is largely independent of the specific tasks of the automation system 1 and of the peripheral units.

The automation controllers 3.1, 3.2 are in the form of identical processors for controlling the peripheral units by means of a respective operating system and at least one application program.

The bus system 4 is in the form of a field bus system, for example in the form of a so-called Profibus (=Process Field Bus).

The automation controllers 3.1, 3.2 are each connected to the bus system 4 by means of an associated switching unit 6.1, 6.2.

Each bus interface assembly 5.1, 5.2, 5.3 has two identical bus controllers 7.1, 7.2 for controlling interchange of data via the bus system 4. In this case, a first bus controller 7.1 is assigned to a first automation controller 3.1 and is permanently connected to the latter via the bus system 4. The second bus controller 7.2 is accordingly assigned to the second automation controller 3.2 and is permanently connected to the latter via the bus system 4.

In the exemplary embodiment illustrated in FIG. 1, a first bus interface assembly 5.1 and a second bus interface assembly 5.2 are directly connected to the bus system 4 in this case via their respective first bus controller 7.1, while the third bus interface assembly 5.3 is connected to the bus system 4 only indirectly via the first bus interface assembly 5.1 to which it is connected via an additional data connection 8. The invention allows exemplary embodiments with accordingly extended or modified networked connections of bus interface assemblies 5.1, 5.2, 5.3. In alternative exemplary embodiments, the bus controllers 7.1, 7.2 of one or more of the bus interface assemblies 5.1, 5.2, 5.3 may furthermore also be connected to the bus system 4 in series.

The two switching units 6.1, 6.2 each have a third bus controller 7.3 for controlling their interchange of data via the bus system 4, and the two automation controllers 3.1, 3.2 each have a fourth bus controller 7.4.

This establishes control redundancy which involves the two automation controllers 3.1, 3.2 simultaneously setting up and maintaining data connections to the peripheral units. On account of the redundant design of the automation controllers 3.1, 3.2, the existence of these data connections enables a sufficiently fast changeover time by changing over between these automation controllers 3.1, 3.2; if these data connections first had to be set up during changeover, the demands imposed on short changeover times, for example in the range of seconds, could not be met.

Two bus controllers 7.1, 7.2 in each bus interface assembly 5.1, 5.2, 5.3 make it possible for each automation controller 3.1, 3.2 to maintain precisely one connection to the peripheral units, each first and second bus controller 7.1, 7.2 being assigned to precisely one automation controller 3.1, 3.2. In this case, the automation controllers 3.1, 3.2 see separate entities of the respective peripheral unit, represented by the two bus controllers 7.1, 7.2. However, in this case, each bus interface assembly 5.1, 5.2, 5.3 and each peripheral unit is advantageously present only once in the form of hardware, with the result that hardware duplication remains restricted to the bus controllers 7.1, 7.2.

FIG. 2 shows a block diagram of the first bus interface assembly 5.1 in more detail. The other bus interface assemblies 5.2, 5.3 have an identical design.

The first bus interface assembly 5.1 comprises a first bus controller 7.1, a second bus controller 7.2, a changeover unit 9 and a memory unit 11. The two bus controllers 7.1, 7.2 are each controlled using bus controller software 13. The memory unit 11 is controlled using a memory driver 15.

The first bus controller 7.1 is directly connected to the bus system 4, while the second bus controller 7.2 is connected to the first bus controller 7.1 and is indirectly connected to the bus system 4 via this connection.

Each item of bus controller software 13 manages, for its bus controller 7.1, 7.2, a separate stack and a separate gateway, via which the respective bus controller 7.1, 7.2 permanently communicates with the automation controller 3.1, 3.2 assigned to it.

Redundancy control (described in more detail below) and the connection between the two bus controllers 7.1, 7.2 are used to inform the first bus interface assembly 5.1 of which of the two automation controllers 3.1, 3.2 is currently controlling the process, that is to say which automation controller 3.1, 3.2 is currently controlling the automation system 1. According to this information, the memory unit 11 and thus also the peripheral unit connected to the first bus interface assembly 5.1 are assigned to one of the two bus controllers 7.1, 7.2 via the changeover unit 9. Information needed in the event of changeover is interchanged between the two bus controllers 7.1, 7.2 via the connection between the two bus controllers 7.1, 7.2.

Redundancy control already mentioned above is used to control which of the two automation controllers 3.1, 3.2 is currently controlling the process. Various methods are already known from the prior art for this redundancy control, which methods are only briefly outlined here, but are not explained in detail on account of the fact that they are known, and can be alternatively and/or cumulatively used:
Subdivision into a primary system and a secondary system: if the first automation controller 3.1 is available and is ready for operation, it controls the process; the second automation controller 3.2 controls the process only if the first controller fails or is not available.
Continuous mutual monitoring of both automation controllers 3.1, 3.2: both automation controllers 3.1, 3.2 permanently monitor one another during continuous operation in order to be able to also detect failure of the automation controller 3.1, 3.2 which is currently not in control.
The continuous monitoring and decision as to which automation controller 3.1, 3.2 controls the process are effected at the level of an application program of the automation controllers 3.1, 3.2, even if the monitoring and decision-making functionality is independent of the respective application.
The continuous monitoring and decision as to which automation controller 3.1, 3.2 controls the process are effected at the level of an operating system of the automation controllers 3.1, 3.2 by a process of the operating system.
Permanent synchronization of the two automation controllers 3.1, 3.2: the control applications on the two automation controllers 3.1, 3.2 always reflect the current operating state of the automation system 1.
Synchronization during changeover: the automation controller 3.1, 3.2 respectively assuming control does not fully know the current operating state of the automation system 1 at the time at which it assumes control and determines said state after changeover, that is to say after it has assumed the control of the automation system 1.
Providing the bus interface assemblies 5.1, 5.2, 5.3 with information relating to the automation controller 3.1, 3.2 which is currently controlling the process: the bus interface assemblies 5.1, 5.2, 5.3 are cyclically informed, at predefinable intervals of time and/or in the event of a change of the controlling automation controller 3.1, 3.2, of which of the two automation controllers 3.1, 3.2 is currently controlling the automation system 1 via the bus system; since the two bus controllers 7.1, 7.2 separately receive this information, it is still necessary to compare said controllers.
Those bus controllers 7.1, 7.2 which are currently not connected to a peripheral unit supply their useful data with a useful data qualifier. In this case, the data may be supplied with a valid or invalid useful data qualifier depending on the implementation. Takeover of access to a peripheral unit by a bus controller 7.1, 7.2 is signaled to the controlling automation controller 3.1, 3.2 by means of an alarm or cyclical data in the header of a message frame; only then does the controlling automation controller 3.1, 3.2 access the useful data of the respective peripheral unit.
That bus controller 7.1, 7.2 of a bus interface assembly 5.1, 5.2, 5.3 which is currently not accessing the associated peripheral unit supplies the useful data of the respective other bus controller 7.1, 7.2 of this bus interface assembly 5.1, 5.2, 5.3; for this purpose, these useful data are transmitted via the coupling between the two bus controllers 7.1, 7.2.

The text below provides a more detailed description of how data can be interchanged via a bus system 4, which is in the form of a Profibus for example, using a network protocol, for example a Profinet protocol.

A domain is set up for each automation controller 3.1, 3.2 on the same physical network, for example an Ethernet network. Each bus interface assembly 5.1, 5.2, 5.3 notifies the automation controllers 3.1, 3.2 of a respective network address for each of its bus controllers 7.1, 7.2 upon start-up. Each of these network addresses is allocated its own device name, for example Door1_P, Door2_P, etc. for the respective first bus controllers 7.1 and Door1_S, Door2_S, etc. for the respective second bus controllers 7.2 in the case of the abovementioned door controller for rail vehicles. Both automation controllers 3.1, 3.2 are planned using separate projects, each automation controller 3.1, 3.2 being individually programmed if the planning software for the bus system 4 does not support the operation of two automation controllers 3.1, 3.2 and two bus controllers 7.1, 7.2 in each bus interface assembly 5.1, 5.2, 5.3. All bus subscribers Door1_P, Door2_P, etc. are then assigned to the first automation controller 3.1 and all bus subscribers Door1_S, Door2_S, etc. are assigned to the second automation controller 3.2.

1-10. (canceled)

11. An automation system, comprising:
a first automation controller and a redundant second automation controller;
at least one peripheral unit;
a bus system connecting said first and second automation controllers and said at least one peripheral unit to one another;
said at least one peripheral unit being connected to said bus system by way of an associated bus interface assembly;
said bus interface assembly having a first bus controller assigned to said first automation controller and being connected to said first automation controller via said bus system, a second bus controller assigned to said second automation controller and being connected to said second automation controller via said bus system, and a changeover unit for changing over between said first and second bus controllers.

12. The automation system according to claim 11, wherein said bus system is a field bus system.

13. The automation system according to claim 11, wherein said first bus controller of a bus interface assembly is directly connected to said bus system, and said second bus controller is connected to said first bus controller and indirectly connected to said bus system through the connection to said first bus controller.

14. A method for operating an automation system, the method which comprises:
providing an automation system according to claim 11;
selecting one of the first and second automation controllers to control the automation system depending on a given situation; and
selecting that bus controller which is assigned to the respectively selected automation controller controlling the automation system to access the peripheral unit in the bus interface assembly of the at least one peripheral unit.

15. The method according to claim 14, which comprises controlling the automation system using the first automation controller if the first automation controller is available for control and is ready for operation, and controlling the automation system using the second automation controller if the first automation controller is not ready for operation or is not available.

16. The method according to claim 14, which comprises continuously monitoring an availability and a readiness for operation of each of the automation controllers.

17. The method according to claim 16, wherein the first and second automation controllers monitor one another for availability and readiness for operation.

18. The method according to claim 14, which comprises informing the bus controllers of the bus interface assembly of the at least one peripheral unit of each change of the automation controller selected to control the automation system via the bus system.

19. The method according to claim 14, which comprises cyclically informing the bus controllers of the bus interface assembly of the at least one peripheral unit, at predefined intervals of time, as to which of the first and second automation controllers is currently selected to control the automation system via the bus system.

20. The method according to claim 14, which comprises, on occasion of a change of the bus controller accessing the at least one peripheral unit, transmitting a current system state of the at least one peripheral unit from the bus controller handing over access to the bus controller assuming access to the peripheral unit.
